(19) United States
(12) Patent Application Publication
(10) Pub. No.: US 2026/0169974 A1
(43) Pub. Date: Jun. 18, 2026

(54) DATA PROCESSING METHOD, APPARATUS, ELECTRONIC DEVICE AND STORAGE MEDIA

(71) Applicant: Beijing Zitiao Network Technology Co., Ltd., Beijing (CN)

(72) Inventors: Liaoyuan Ning, Beijing (CN); Wenbin Zhang, Beijing (CN); Cong Wang, Beijing (CN); Qiang Mao, Beijing (CN); Kuang Han, Beijing (CN); Zheng Li, Beijing (CN)

(21) Appl. No.: 18/708,144

(22) PCT Filed: Dec. 9, 2022
(86) PCT No.: PCT/CN2022/138016

§ 371 Date: May 7, 2024

(30) Foreign Application Priority Data
Dec. 27, 2021 (CN) 202111612715.9

(51) Int. Cl. G06F 16/23; G06F 16/28

(52) U.S. Cl. CPC G06F 16/23; G06F 16/288

(57) ABSTRACT

The present disclosure provides data processing method, apparatus, electronic device and storage media. A data processing method, including: in response to a first operation on the first table, determining data in the first table; updating data in a second table in the target database, based on the data in the first table; wherein, the first table being an online form located outside the target database, the first table has an associated relationship with the second table. By using an online table outside the target database as the interface for user interaction, the data in the target database may be operated through the online form without the need to develop a separate management system, thus reducing development costs. In addition, the online document has diffusion characteristic and can be processed collaboratively by multiple people at the same time, meeting the needs of multiple users.

### CROSS REFERENCE TO RELATED APPLICATION

This application is filed based on and claims priority to Chinese Patent Application No. 202111612715.9, filed on Dec. 27, 2021, titled “DATA PROCESSING METHOD, APPARATUS, ELECTRONIC DEVICE AND STORAGE MEDIA”, which is incorporated herein by reference in its entirety.

### FIELD

The present disclosure relates to computer field, and particularly related to a data processing method, apparatus, electronic device and storage medium.

### BACKGROUND

In the field of information processing, a database is usually used to store data. Developers usually develop a management system according to the needs of business personnel, retrieving and displaying the data in the database through the management system.

### SUMMARY

The present disclosure provides a data processing method, apparatus, electronic device and storage medium.

The present disclosure adopts the following technical solutions.

In some embodiments, the present disclosure provides a data processing method, comprising:
In response to the first operation on the first table, determining data in the first table;
Updating the data in the second table in the target database based on the data in the first table; wherein the first table is an online table located outside the target database, the first table has an association relationship with the second table.

In some embodiments, the present disclosure provides a data processing apparatus, including:
a determining unit configured to determine the data in the first table in response to a first operation on the data in the first table;
an update unit, configured to update the data in the second table in the target database based on the data in the first table; wherein the first table is an online table located outside the target database, the first table has an associated relationship with the second table.

In some embodiments, the present disclosure provides an electronic device including: at least one memory and at least one processor;
wherein the memory being used to store program code, and the processor being used to invoke the program code stored in the memory to execute the above method.

In some embodiments, the present disclosure provides a computer-readable storage medium for storing program code that, in response to being run by a processor, the program code causes the processor to perform the above method.

The data processing method provided by the present disclosed embodiments uses an online table (first table) located outside the target database as an interface of user interaction, and performs operation on the data(such as addition, deletion, modification, and query) in the target database through the online table without the need to develop a separate management system, thereby reducing development costs, and an online document has a diffusion characteristic and can be processed collaboratively by multiple people at the same time, thereby meeting the needs of multiple users.

### BRIEF DESCRIPTION OF THE DRAWINGS

The above and other features, advantages and aspects of various embodiments of the present disclosure will become more apparent with reference to the following DETAILED DESCRIPTION in conjunction with the accompanying drawings. Throughout the drawings, the same or similar reference numbers refer to the same or similar elements. It should be understood that the drawings are schematic, components and elements are not necessarily drawn to scale.

FIG. 1 is a flow chart of the data processing method of embodiment of the present disclosure.

FIG. 2 is a schematic diagram of a first table of embodiment of the present disclosure.

FIG. 3 is a schematic diagram of the first configuration table of embodiment of the present disclosure.

FIG. 4 is a schematic diagram of the second configuration table of embodiment of the present disclosure.

FIG. 5 is an interaction diagram of the data processing method of embodiment of the present disclosure.

FIG. 6 is a schematic structural diagram of an electronic device of embodiment of the present disclosure.

### DETAILED DESCRIPTION

Embodiments of the present disclosure will be described in more detail below with reference to the accompanying drawings. Although certain embodiments of the disclosure are shown in the drawings, it should be understood that the present disclosure may be implemented in various forms and should not be interpreted as limitation to the embodiments set forth herein, in contrast these embodiments are provided for understanding the present disclosure more clearly and thoroughly. It should be understood that the drawings and embodiments of the present disclosure are for illustrative purposes only and are not intended to limit the scope of the present disclosure.

It should be understood that various steps described in the method embodiments of the present disclosure may be performed and/or in parallel. Furthermore, method embodiments may include additional steps and/or omit performance of illustrated steps. The scope of the present disclosure is not limited in this regard.

As used herein, the term “include” and its variations are open-ended, i.e. “including but not limited to.” The term “based on” means “based at least in part on.” The term “an embodiment” means “at least one embodiment”; the term “another embodiment” means “at least one another embodiment”; the term “some embodiments” means “at least some embodiments”. Relevant definitions of other terms will be given in the description below.

It should be noted that concepts such as “first” and “second” mentioned in the present disclosure are only used to distinguish different apparatuses, modules or units, and are not used to limit the interdependences or order of functions performed by these apparatuses, modules or units.

It should be noted that the modification of “a” mentioned in the present disclosure is illustrative rather than restrictive. Those skilled in the art will understand that unless the context clearly indicates, the modification of “a” should be understood as “one or more”.

The names of messages or information exchanged between a plurality of apparatuses in the embodiments of the present disclosure are for illustrative purposes only and are not used to limit the scope of these messages or information.

The solution provided by the embodiments of the present disclosure will be described in detail below with reference to the accompanying drawings.

Each of a variety of systems often uses a database to store data. Developers develop management systems to enable business personnel to perform configuration management, data maintenance, duration statistics, etc. The approach of developing a management system requires continuous iteration according to needs. The development cost is high, and the interaction approach of interacting through software interface is not convenient for data management and operation.

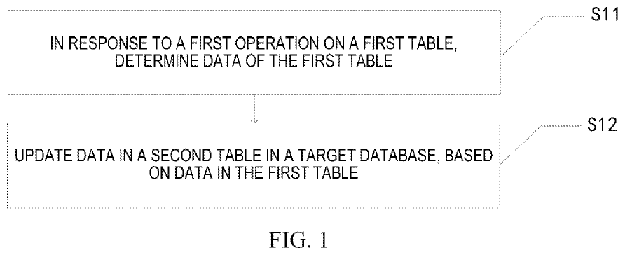

As shown in FIG. 1, FIG. 1 is a flow chart of the data processing method of embodiments of the present disclosure, including the following steps.

S11: In response to the first operation on the first table, determine the data in the first table.

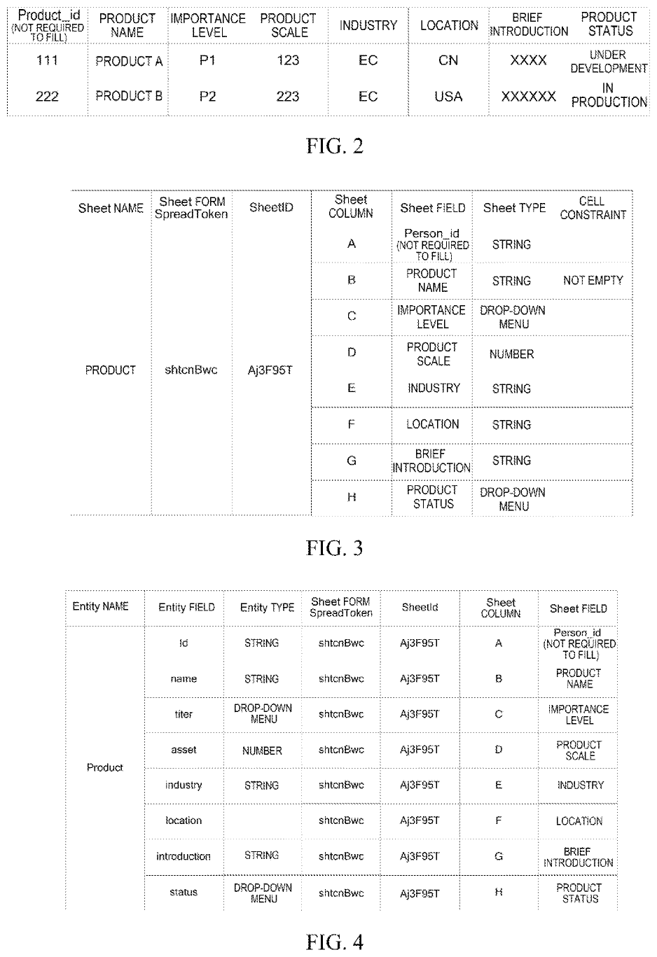

In some embodiments, the first table is an online table located outside the target database, that is, the first table is not a table that stores data in the target database, and the first table is an online table. For an online table, it can be used by multiple people to open and access the first table on different terminals for collaborative processing. Data is stored in the first table. The first operation on the first table may be, for example, an operation of saving data, an operation of closing the first table, etc., after detecting the first operation, that is, the data in the first table is determined, in some embodies, the area of the first table can be divided into a header and a data area. Please refer to FIG. 2. The header is usually the first row of a column, which usually represents the data name of a column, for example, in FIG. 2, the first column is “Product_id”, the second column is “Product Name”, and the third column is “Importance Level”, in the first row of FIG. 2, “Product_id”, “Product Name” “and “Importance Level” are the headers, and the data in the second row and the third row in FIG. 2 are the data corresponding to each header.

S12: Update the data in the second table in the target database, based on the data in the first table.

In some embodiments, the second table is a table that stores data in the target database, and the first table has an associated relationship with the second table, in some embodiments, the data in the first table has an association relationship with the data in the second table. After determining the data in the first table, determine the associated data in the second table based on the association relationship, and synchronize the data in the first table to the second table, thereby updating the associated data in the second table.

In some embodiments of the present disclosure, an online table (the first table) outside the target database is used as an interface of user interaction, and the data in the target database is operated through the online table (such as addition, deletion, modification, and query) without the need to develop an individual management system, thereby reducing the development cost, and an online document has diffusion characteristic and can be processed collaboratively by multiple people at the same time, meeting the needs of multiple users.

In some embodiments of the present disclosure, before responding to the first operation on the first table, the method further includes: creating the first table based on the target database. In some embodiments, the establishment of the first table is related to the target database, thereby ensuring that the data in the first table meets the requirements of the target database. The first table may be bound to the target database upon the creation of the first table.

In some embodiments of the present disclosure, creating the first table based on the target database includes: displaying the header of the data table of the target database and the data type corresponding to the header; determining the first header of the first table and the first data type; generating the first table according to the first header of the first table and the first data type.

In some embodies, the data in the first table needs to be synchronized to the target database, so it is necessary to know what data is stored in the target database, this can be known from the header in the target database. Obtaining the header of the target database means knowing the data that can be operated, and the database has strict data type restrictions. The data in a field must be a specific type of data, otherwise an error will be reported. Therefore, it is also necessary to know the data type of each header in the target database, otherwise it may cause the data in the first table unable to be synchronized to the target database. After determining the header stored in the target database and the data type corresponding to the header, the header of the first table may be edited. The header in the first table has a corresponding relationship with the header in the target database. it is necessary to ensure that the header of the first is in consistent with the corresponding datatype of the header in the target database, thereby ensuring that data synchronization is able to be proceed. In the present embodiment, the header in the first table and the data type are determined through the header in the target data base and data type, thereby ensuring that the data in the first table can be synchronized to the target database. Supported data types include: strings, numbers, pictures, and emails, etc.

In some embodiments of the present disclosure, determining the first header and the first data type of the first table based on the header of the data table and data type of the target database includes: creating a first configuration table, the first configuration table being used to store the first header of the first table, the first data type and the identification of the first table, the first configuration table is an online table located outside the target database. Generating the first table may specifically be, generating the first table according to the first configuration table.

In some embodiments, after determining the header of the target database and data type, create the first configuration table (refer to FIG. 3), and store the header of the first table in the first configuration table (Sheet field in FIG. 3) and the data type (Sheet type in FIG. 3), of course, the first configuration table may also store the identification of the first table (SpreadToken and SheetID in FIG. 3), the column position of each header in the first table (Sheet column in FIG. 3), constraints of each table header (cell constraints in FIG. 3, such as whether to allow being empty), the first configuration table is used to create the first table, upon creating the first table, create the first table according to information such as the table identification, table header, data type and the like of the first table stored in the first configuration table. In some embodiments, after the first configuration table is generated, create the first table, causing the information of the first table conforms to the information in the first configuration table based on the information of the first table written in the first configuration table, such as the header in the first table, the data type corresponding to the header, cell constraint, column position of the header in the first table, table name of the first table, identification of the first table and the like, the first table. The first configuration table is created in the embodiments of the present disclosure, so that the constraints such as the type restrictions of each data in the first table can be visually viewed, thereby causing the user to know the specifications and standards that need to be followed upon inputting data in the first table, achieving visual viewing, and if there is no first configuration table, the user is unable to directly know the limitations of each data in the first table. In particular, general tables (such as Excel) are weakly typed data, in which input data cannot be restricted, while the data stored in the database are all strongly typed data, each data in the database can only be the data of a specific data type. Therefore, by setting the first configuration table, the problem of an association relationship between the first table and the table header is solved, and it is advantageous to ensure that the data of the first table and the target database is able to be synchronized successfully, and the first configuration table is equivalent to the template for generating the first table, which may be reused later, thereby generating the table repeatedly, simplifying the step of creating of the table. In some embodiments of the present disclosure, before responding to the first operation on the first table, the method further includes: creating the second table associated with the first table in the target database according to the relevant information of the first table.

In some embodiments, the information related to the first table may include information related to the attributes or content of the first table, for example, the header of the first table, the data type of the data in the first table, the table identifier of the first table, and the like. After obtaining the relevant information of the first table, create a second table in the target database. The number of the second table may be one or more, which is used to store data. The data of the first table is stored in the target database through the second table. Since the second table is a table in the target database, the second table must meet the requirement of the data. The field in the table (such as a column of data upon storing rows, or a row of data upon storing columns) meet the requirement of a specific data type, therefore upon creating the second table, referring to the relevant information in the first table to ensure that the restrictions on the data in the second table match the restrictions on the associated data in the first table is needed, so as to ensure that the data in the first table is able to be synchronized to the second table.

In some embodiments of the present disclosure, creating the second table associated with the first table in the target database according to the relevant information of the first table, includes: determining the second header of the second table and the second data type according to the first table of the first table and the first data type; creating the second table according to the second header of the second table and the second data type and associating the first table with the second table.

In some embodiments, the second table is a table stored in the target database. Therefore, the data type of the header of the first table and the header associated with the second table need to be consistent, so as to ensure that the data in the first table is able to be synchronized to the second table, upon creating the second table, an association relationship between the first table and the second table is established, further, establishing an association relationship between the header in the first table and the header in the second table. Take the first table and the second table as an example of row storage, a header in the first table and the second table is the name of a column, such as “Product Name” in the first row in FIG. 2, in the second table there is a column associated with the “Product Name” column in FIG. 2 which can be the “name” column in the second table, so that the data in the first table may determine the column associated in the second table according to the column in the first table in where the data is located, thereby synchronizing data to the associated columns.

In some embodiments of the present disclosure, associating the second table with the first table includes: creating a second configuration table, the second configuration table being used to the association relationship between the second table and the first table, the association relationship between the second header and the first header; wherein the second configuration table is an online table located outside the target database; generating the second table according to the second configuration table.

In some embodiments, after determining the table header of the second table and the data type according to the header of the first table and data type, create a second configuration table, storing the header in the second table and data type corresponding to the header in the second configuration table. For details, please refer to FIG. 4. The second configuration table stores the identification of the second table (Entity name), each header of the second table (Entity field), the data type of the header of the second table. (Entity type), the associated identification of the first table (Sheet form SpreadToken and SheetId), the header in the second table is associated with the header of the first table, therefore the header of the first table specifically associated with the second table is also recorded (Sheet field), the header of the second table further records the location of the header in the first table (Sheet column). In this way, the association relationship between the second table and the first table may be established through the second configuration table, establishing the association relationship between the header in the second table and the header in the first table, defining the data type requirement of the second table. Upon establishing the second table, establish the second table based on the header of the second table and data type defined in the second configuration table. In some embodiments, an identification may be assigned to the second table according to the identification of the second table recorded in the second configuration table. Establish the header in the second table and define the data type based on information such as the header in the second configuration table, data type and the like. In this embodiment, the association relationship between the first table and the second table, the association relationship between the header in the second table and the header in the second table are intuitively displayed through the second configuration table, so that the user does not need to use query language to query in the database about the association relationship between tables. On one hand, the association relationship between tables can be displayed visually, on the other hand, it reduces the requirement for the user and greatly improves the user experience.

In some embodiments of the present disclosure, the number of the second tables is equal or greater than two; the second configuration table also stores an association relationship between at least two of the second tables. In some embodiments, a second table may be associated with another second table, for example, through a foreign key. The association relationship between different second tables is recorded in the second configuration table at the same time, so that there is no need to perform query operation in the target database.

In some embodiments of the present disclosure, before updating the data in the second table based on the data in the first table, the embodiment further includes: verifying the first table to determine that the first table satisfies verification requirement. In some embodiments, the data in the first table needs to be updated synchronously to the second table. The second table is the table in the target database. The data in the second table must meet the requirement of the target database, therefore the first table needs to be verified to ensure the smooth progress upon updating the data synchronously.

In some embodiments of the present disclosure, verifying the first table includes: verifying the data type of the current data in the first table. In some embodies, the data written in the first table needs to meet the requirement of the data type corresponding to the table header where the data is located, otherwise the data is unable to be written to the target database. In some embodiments, verifying the data type of the current data in the first table includes: obtaining the first data type of the data of the first table from the first configuration table; determining the data type of the current data in the first table conforms to the first data type. In this embodiment, upon verifying the data type of the first table, the operation is not performed through the target database, but through two tables which are the first table and the first configuration table outside the target database. Therefore, the user does not need to learn the operation language of the database, which reduces the user's learning and using requirement.

In some embodiments of the present disclosure, verifying the first table includes: verifying the header of the first table. In some embodiments, the header in the first table has an association relationship with the header in the second table. The association relationship between the header in the first table and the header in the second table is established based on the row or column in which they are located and is recorded in the second configuration table, if the row or column of the header in the first table changes, or the content changes, it will cause confusion of the association relationship and synchronization errors. Therefore, in some embodiments, it is prohibited to edit the header in the first table. Therefore, in some embodiments, verifying the header of the first table includes: obtaining the first header of the first table from the first configuration table, determining the current header in the first table is in consistent with the first header stored in the first configuration table, thereby determining that the header in the first table is unchanged.

In some embodiments of the present disclosure, verifying the first table includes: verifying the association relationship between the first table and the second table. In some embodiments, the first table has an association relationship with the second table. The associated identification can be stored in the first table, if the identification changes, it may cause errors upon data synchronization, therefore verification is required. In some embodiments, verifying the association relationship between the first table and the second table includes: determining that the target row or column in the first table is in a frozen state, and the target row or column being used to store the row or column identification of the row or column data located in the second table associated with the data in the first table. In some embodiments, the target row or column is used to store row or column identification, if the first table uses row storage, then the row or column data may be a certain row of data, if the first table uses column storage, then the row or column data may be a certain column of data, the row or column identification is used to indicate the row or column data located in the second table associated with the data in the first table. If the second table uses row storage, the table header represents a certain column, the row or column identification is used to locate the data in a certain row. If column storage is used, the table header represents a certain row, the row or column identification is used to locate the data in a certain column. The data in a specific cell position in the table can be uniquely located through the header and row or column identification. Specifically, taking row storage as an example, the header in the first table is associated with the header in the second table, such that, it is able to be known that the column in the second table corresponding to the data in the first table, but it is unable to be known that which row of data in the column the data in the first table corresponds to. Therefore, it is necessary to determine which row in the column the data in the first table is associated with through the row or column identification. The target row or column in the first table stores the row and row identification associated with the data in the first table. In the target database, taking row storage as an example, a row of data generally has a primary key, and the primary key may be used as the row or column identification of the row of data. Please refer to FIG. 2, the first column where Product_id is located in FIG. 2 is the target row, which stores the row or column identification (primary key) of a row of data in the second table associated with a row of data in the first table, different rows in the first table may associated with different rows of data in the second table. The target row or column in the first table is automatically generated and added according to the association relationship, user editing is prohibited, therefore it should be in a frozen state. If it is not in a frozen state, then the verification requirement is not satisfied.

In some embodiments of the present disclosure, updating the data in the second table associated with the first table includes: determining a target header located in the second table s associated with the data in the first table; determining the target row or row data located in the second table associated with the data in the first table; updating the data corresponding to the target header in the target row and column data of the second table.

In some embodies, upon updating, a certain data in the first table that needs to be updated is used as the target data, which has a corresponding header. For example, the header of “Product A” in FIG. 2 is “Product Name”, the data has associated target row or column data (the data in the Product_id column in FIG. 2 is the row or column identification of the target row and row data, the target row or column data may be determined based on the target row or column identification), that is, a row of data in the second table (upon row storage) or a column of data in the second table(upon column storage), the target row or column data comprises one or more sub-data, the sub-data in the target row or column data also has corresponding header (the headers of each sub-data are respectively associated with headers such as the “Product Name”, “Importance Level”, “Product Scale” and the like in FIG. 2), through the association relationship between the first header and the second header recorded in the second configuration table, determine the target header located in the second table associated with the header where the target data is located, the sub-data corresponding to the target header is the data that needs to be updated according to the target data.

In some embodiments of the present disclosure, updating the data in the second table associated with the first table includes: determining a target header located in the second table associated with the data in the first table; determining whether the target row or column identification associated with the data of the first table is stored in the target row or column of the first table, the target row or column identification is the identification of the target row or column data in the second table; if yes, then updating the data corresponding to the target header in the row or column data corresponding to the row or column identification according to the data in the first table; if otherwise, then creating the row or column data in the second table according to the data in the first table, and obtaining the target row or column identification of the target row or column data, writing the obtained target row or column identification in the first table to establish the association relationship between the data in the first table and the target row or column identification.

In some embodiments, as shown in FIG. 2, taking row storage as an example, the first column in FIG. 2 is the target row or column, which is used to store the row or column identification associated with a row of data in the first table. Upon updating the second table according to the data of the first table, obtain the target row or column identification of the associated target row or column data from the target row or column. If the target row or column identification is able to be obtained, then update the target row or column identification. If the target row or column identification is unable to be obtained, then it indicates that the data in the first table fails to have the data in the second table associated with it, the entire row of data of the row where the data is located in the first table may be a newly added row data. Therefore, upon this situation, adding the row data associated with it (target row or column data) in the second table, and return the primary key (target row or column identification) of the newly added row data in the second table to the first table for storage, such that the corresponding update is able to be made next time, which may be the same row of the data stored in the first table.

In some embodiments of the present disclosure, determining the target header located in the second table associated with the data in the first table includes: determining the header where the data in the first table is located; determining the target header associated with the header where the data in the first table is located according to the association relationship between the second header of the second table and the first header of the first table stored in the second configuration table. In some embodiments, there is no need to maintain the association relationship through the target database, instead, the association relationship is maintained and used through an online table such as a second configuration table outside the target database, which greatly reduces development costs and there is no need for users to learn database operating language.

In some embodiments of the present disclosure, writing the obtained target row or column identification in the first table includes: writing the target row or column identification in the target row or column of the first table and freezing the target row or column identification. In some embodies, the target row or column are frozen, so the user is unable to operate it, which avoids confusion in association relationship caused by user operation. For example, the first column in FIG. 2 is the target row or column.

In some embodiments of the present disclosure, updating the data in the second table associated with the first table based on the data in the first table includes: determining difference between the data in the first table and the data of the associated second table; determining the data set that needs to be updated based on the difference; updating the data in the second table based on the data set. In some embodiments, the update is performed based on the difference to avoid overburdening the target database due to large amount of data reading and writing.

In some embodiments of the present disclosure, the embodiments further include: in response to a sharing operation on the first table, sharing the first table to the target user. Upon the target user operating the first table, determine the allowed operation based on the target user's permission information for the first table. The permission information includes reading permission and editing permission. If the user sharing the first table has the editing permission for the first table, and the target user only has the reading permission, then the target user is only allowed to read the first table. In other embodiments, after the target table is shared to the target user, a permission application entrance may be provided. The permission application entrance is used for applying for the permission, upon the target user having insufficient permissions, the target user is able to apply for the reading permission or the editing permission through the permission application entrance. The permission application entrance may be a control that sends information to the administrator of the first table.

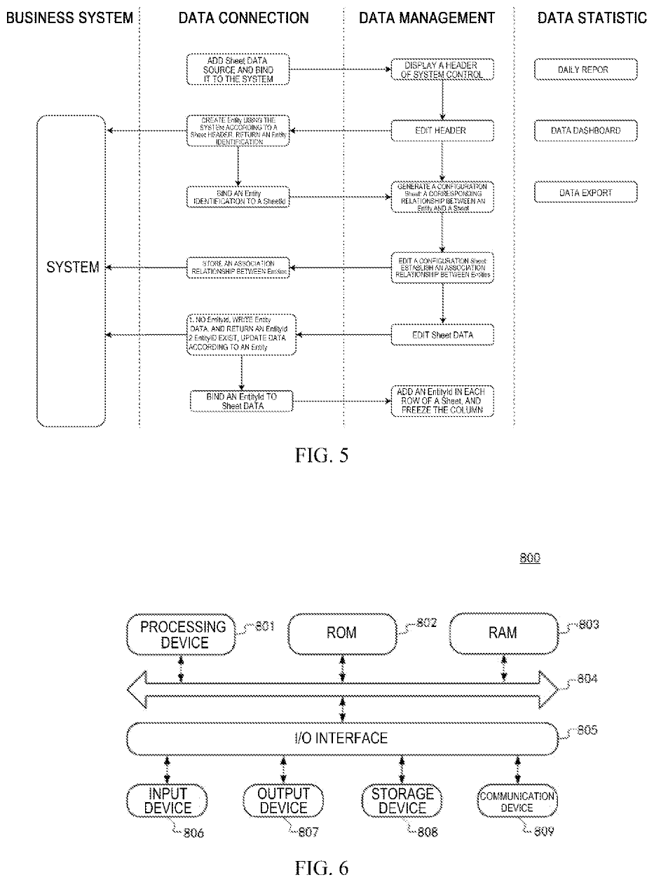

In order to better explain the method proposed in the embodiments of the present disclosure, a specific embodiment is proposed below. Please refer to FIG. 5. The present embodiment may be used to make daily report, data dashboard, data export, etc. In this embodiment, first, add the Sheet data source and bind it to the system. Sheet is the first table, which establishes the association relationship between the first table and the system (target database) and displays the header of the data table of system. Perform editing based on the user's need, therefore determining the Sheet header (the first header of the first table), creating the Entity (the second table) based on the Sheet header and returning the Entity identification, binding the Entity identification to the SheetID (the first table and the second table are bonded through their respective identifications), generating the configuration Sheet (the second configuration table), which is used to store the corresponding relationship between Entity and Sheet, editing the configuration Sheet, establishing the corresponding relationship between Entity and Sheet. If there is an association relationship between Entity, then store and notify the system, edit the Sheet data (data in the first table), determine whether the data has an associated Entity ID (target row or column identification, usually the primary key), if there is no an association relationship between Entity, then write the Entity data and return the EntityID (Write data in the second table and return the row or column identification of the written data), if there is an EntityID, then determine the data based on the EntityID and update it, bind the returned EntityID to the Sheet data. The specific binding method is, adding a new column in each row of Sheet, the new column is used to store the associated EntityID and freeze the column.

The embodiments of the present disclosure further propose a data processing apparatus, including:
a determining unit, in response to a first operation on a first table, determines data in the first table;
an updating unit, updates data in a second table in a target database based on the data in the first table; wherein, the first table is an online table located outside the target database, the first table and the second table are in an association relationship.

In some embodiments, the embodiments further include a creating unit for creating the first table based on the target database before responding to the first operation on the first table.

In some embodiments, the creating unit creates the first table based on the target database, including: displaying the header of the data table of the target database and the data type corresponding to the header; determining the first header of the first table and the first data type based on the header of the data table of the target data base and data type; generating the first table according to the first header of the first table and the first data type.

In some embodiments, determining the first header of the first table and the first data type based on the header of the data table of the target database and data type, includes: creating a first configuration table, the first configuration table is used for storing the first header of the first table, the first data type and the identification of the first table, the first configuration table is an online table located outside the target database; generating the first table according to the first configuration table.

In some embodiments, the embodiments further include a creating unit for creating the second table associated with the first table in the target database according to the relevant information of the first table before responding to the first operation on the first table.

In some embodiments, the creating unit creates the second table associated with the first table in the target database according to the relevant information of the first table, including: determining the second header of the second table and the second data type according to the first header of the first table and the first data type; creating the second table and associating the first table with the second table according to the second header of the second table and the second data type.

In some embodiments, associating the second table with the first table includes: creating a second configuration table, the second configuration table being used to store the association relationship between the second table and the first table, the second header, the association relationship between the second header and the first header; wherein the second configuration table is an online table located outside the target database; generating the second table according to the second configuring table.

In some embodiments, the number of the second tables is equal or greater than two; the second configuration table further stores an association relationship between at least two of the second tables.

In some embodiments, the embodiments further include a verifying unit for verifying the first table and determining that the first table meets the verification requirement before performing an update on the data in the second table based on the data in the first table.

In some embodiments, verifying the first table includes at least one of the following: verifying the data type of the current data in the first table; verifying the header of the first table; Verifying the association relationship between the first table and the second table.

In some embodiments, at least one of the following is satisfied: verifying the data type of the current data in the first table, including: obtaining the first data type of the data in the first table from the first configuration table; determining the data type of the current data in the first table conforms to the first data type; verifying the header of the first table includes: obtaining the first header of the first table from the first configuration table, determining that the current header in the first table is in consistent with the first header stored in the first configuration table; verifying the association relationship between the first table and the second table, including: determining the target row or column in the first table is in a frozen state, the target row or column being used to store the row or column identification of the row and column data located in the second table associated with the data in the first table.

In some embodiments, updating the data in the second table associated with the first table includes: determining the target header located in the second table associated with the data in the first table; determining the target row or column data located in the second table associated with the data in the first table; updating the data corresponding to the target header in the target row or column data of the second table according to the data in the first table.

In some embodiments, updating the data in the second table associated with the first table includes: determining the target header located in the second table associated with the data in the first table; determining whether the target row or column identification associated with the first table is stored in the target row or column of the first table, the target row or column identification is the identification of the target row or column data in the second table; if yes, then updating the data corresponding to the target header in the row or column data corresponding to the row or column identification according to the data in the first table; if otherwise, then creating target row or column data in the second table, and obtaining the target row or column identification of the target row or column data, writing the obtained target row or column identification in the first table to establish an association relationship between the data in the first table and the target row or column identification according to the data in the first table.

In some embodiments, determining the target header located in the second table associated with the data in the first table includes: determining the header where the data in the first table is located; determining the target header associated with the header where the data in the first table is located, according to the association relationship between the second header of the second table and the first header of the first table stored in the second configuration table.

In some embodiments, writing the obtained target row or column identification in the first table includes: writing the target row or column identification in the target row or column of the first table and freezing the target row or column identification.

In some embodiments, based on the data in the first table, updating the data in the second table associated with the first table includes: determining the difference between the data of the first table and the associated data of the second table; determine the data set that needs to be updated based on the difference; updating the data in the second table according to the data set.

For the embodiments of the apparatus, since they basically correspond to the method embodiments, please refer to the description of the method embodiments for relevant information. The apparatus embodiments described above are only illustrative, and the modules described as separate modules may or may not be separate. Part of or all of the modules may be selected within according to actual needs to achieve the purpose of this embodiment solution. Those of ordinary skill in the art can understand and implement the method embodiments without any creative effort.

Above, the method and apparatus of the present disclosure have been described based on embodiments and application examples. In addition, the present disclosure further provides an electronic device and a computer-readable storage medium. These electronic devices and computer-readable storage media are described below.

Referring to FIG. 6, a schematic structural diagram of an electronic device (such as a terminal device or a server) 800 suitable for implementing embodies of the present disclosure is shown. Terminal devices in embodiments of the present disclosure may include, but are not limited to, mobile phone, notebook computer, digital broadcast receiver, PDA (Personal Digital Assistant), PAD (Tablet), PMP (Portable Multimedia Player), vehicle-mounted terminal (e.g., vehicle-mounted Mobile terminal such as navigation terminal) and fixed terminal such as digital TV, desktop computer, etc. The electronic device shown in the figure is only an example and should not bring any limitations to the functions and scope of use of the embodiments of the present disclosure.

The electronic device 800 may include a processing device (e.g., central processing unit, graphics processor, etc.) 801 which may be loaded into a random access memory (RAM) 803 from a program stored in a read-only memory (ROM) 802 or from a storage device 808 to perform various appropriate actions and processes. In the RAM 803, various programs and data required for the operation of the electronic device 800 are also stored. The processing device 801, ROM 802 and RAM 803 are connected to each other via a bus 804. An input/output (I/O) interface 805 is also connected to bus 804.

Generally, the following devices may be connected to the I/O interface 805: input device 806 including, for example, a touch screen, touch pad, keyboard, mouse, camera, microphone, accelerometer, gyroscope, etc.; output device 807 including, for example, a liquid crystal display (LCD), a speaker, vibrator etc.; a storage device 808 including, for example, a magnetic tape, a hard disk, etc.; and a communication device 809. The communication device 809 may allow the electronic device 800 to communicate wirelessly or wiredly with other devices to exchange data. Although electronic device 800 having various of devices is shown in the figure, it should be understood that the electronic device 800 is not required to be implemented with or be equipped with all of the illustrated devices. The electronic device 800 may alternatively be implemented or be equipped with more of fewer devices.

In particular, according to embodiments of the present disclosure, the processes described above with reference to the flowcharts may be implemented as computer software programs. For example, embodiments of the present disclosure include a computer program product, which includes a computer program carried on a computer-readable medium, the computer program containing program code for executing the method shown in the flowchart. In such embodiments, the computer program may be downloaded and installed from the network via the communication device 809, or installed from the storage device 808, or installed from the ROM 802. When the computer program is executed by the processing device 801, the above-mentioned functions defined in the method of embodiments of the present disclosure are performed.

It should be noted that the computer-readable medium mentioned above in the present disclosure may be a computer-readable signal medium or a computer-readable storage medium, or any combination of the above two. The computer-readable storage medium may be, for example, but is not limited to, an electrical, magnetic, optical, electromagnetic, infrared, or semiconductor system, apparatus or device, or any combination thereof. More specific examples of computer readable storage media may include, but are not limited to: an electrical connection having one or more wires, a portable computer disk, a hard drive, random access memory (RAM), read only memory (ROM), erasable programmable read-only memory (EPROM or flash memory), optical fiber, portable compact disk read-only memory (CD-ROM), optical storage device, magnetic storage device, or any adequate combination of the above. In the present disclosure, a computer-readable storage medium may be any tangible medium that contains or stores a program, the program may be used by or used in combine with an instruction execution system, apparatus, or device. In the present disclosure, a computer-readable signal medium may include a data signal propagated in baseband or as part of a carrier wave, carrying computer-readable program code therein. Such propagated data signals may take many forms, including but not limited to electromagnetic signals, optical signals, or any adequate combination of the above. A computer-readable signal medium may also be any computer-readable medium other than a computer-readable storage medium that can send, propagate, or transmit a program use by or used in combination with an instruction execution system, apparatus, or device. Program code carried on a computer-readable medium may be transmitted using any adequate medium, including but not limited to: wire, optical fiber cable, RF (radio frequency), etc., or any adequate combination thereof.

In some embodiments, the client and server can communicate using any currently known or future developed network protocol such as HTTP (HyperText Transfer Protocol), and can interconnect with digital data in any form or medium (e.g., communications networks). Examples of communications networks include local area networks (“LAN”), wide area networks (“WAN”), the Internet (e.g., the Internet), and end-to-end networks (e.g., ad hoc end-to-end networks), as well as any currently known or future developed network.

The above-mentioned computer-readable medium may be included in the above-mentioned electronic device; the computer-readable medium may also exist independently without being assembled into the electronic device.

The above-mentioned computer-readable medium carries one or more programs. Upon executing the above-mentioned one or more programs by the electronic device, the above-mentioned one or more programs cause the electronic device to perform the above-mentioned method of the present disclosure.

Computer program code for performing the operations of the present disclosure may be written in one or more programming languages or combination thereof, including object-oriented programming languages such as Java, Smalltalk, C++, and conventional procedural programming language-such as “C” or a similar programming language. The program code may execute entirely on the user's computer, execute partly on the user's computer, execute as a stand-alone software package, execute partly on the user's computer and partly on a remote computer or execute entirely on the remote computer or server. In situations involving remote computers, the remote computer can be connected to the user's computer through any kind of network, including a local area network (LAN) or a wide area network (WAN), or it can be connected to an external computer (such as a making use of Internet service provider through Internet connection).

The flowcharts and block diagrams in the accompanying drawings illustrate the architecture, functionality, and operations of systems, methods, and computer program products that may be implemented in accordance with various embodiments of the present disclosure. In this regard, each block in the flowchart or block diagram may represent a module, segment, or portion of code that contains one or more executable instructions that implement the specified logic functions. It should also be noted that, in some implementations as alternative, the functions noted in the block may occur out of the order noted in the figures. For example, two blocks shown one after another may actually execute substantially in parallel, or they may sometimes execute in the reverse order, depending on the functionality involved. It should be noted that each block of the block diagram and/or flowchart diagram, and combinations of blocks in the block diagram and/or flowchart diagram, can be implemented by specialized hardware-based systems that perform the specified functions or operations, or can be implemented using a combination of specialized hardware and computer instructions.

The units involved in the embodiments described in the present disclosure may be implemented in software or hardware. Wherein, the name of a unit does not constitute a limitation on the unit itself under certain circumstances.

The functions described above herein may be performed, at least in part, by one or more hardware logic components. For example, and without limitation, exemplary types of hardware logic components that may be used include: Field Programmable Gate Array (FPGA), Application Specific Integrated Circuit (ASIC), Application Specific Standard Product (ASSP), Systems on Chip (SOC), Complex Programmable Logical device (CPLD) and so on.

In the context of the present disclosure, a machine-readable medium may be a tangible medium that may contain or store a program used by or in used in combination with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, devices or devices, or any adequate combination of the foregoing. More specific examples of machine-readable storage media would include one or more wires based electrical connection, portable computer disk, hard drive, random access memory (RAM), read only memory (ROM), erasable programmable read only memory (EPROM or flash memory), optical fiber, portable compact disk read-only memory (CD-ROM), optical storage device, magnetic storage device, or any adequate combination of the above.

According to one or more embodiments of the present disclosure, a data processing method is provided, including:
in response to the first operation on the first table, determining data in the first table;
updating the data in the second table in the target database based on the data in the first table; wherein the first table is an online table located outside the target database, the first table has an association relationship with the second table.

According to one or more embodiments of the present disclosure, a data processing method is provided, before responding to the first operation on the first table, the one or more embodiments of the present disclosure further includes:
creating a first table based on the target database.
a data processing method is provided, creating a first table based on the target database according to one or more embodiments of the present disclosure, including:
displaying the header of the data table of the target database and the data type corresponding to the header;
determining the first header of the first table and the first data type based on the header of the data table of the target database and data type;
generating the first table according to the first header of the first table and the first data type.

According to one or more embodiments of the present disclosure, a data processing method is provided, which determines the first header of the first table and the first data type based on the header of the data table of the target database and data type, the method includes: creating a first configuration table, the first configuration table being used to store the first header of the first table, the first data type and the identification of the first table, the first configuration table is an online table located outside the target database;
generating the first table according to the first configuration table.

According to one or more embodiments of the present disclosure, a data processing method is provided, before responding to the first operation on the first table, the method further includes:
creating the second table associated with the first table in the target database according to the relevant information of the first table.

According to one or more embodiments of the present disclosure, a data processing method is provided, creating the second table associated with the first table in the target database according to the relevant information of the first table, including:
determining the second header of the second table and the second data type based on the first header of the first table and the first data type;
creating the second table and associating the first table with the second table according to the second header of the second table and the second data type.

According to one or more embodiments of the present disclosure, a data processing method is provided, associating the second table with the first table, including: creating a second configuration table, the second configuration table being used to store the association relationship between the second table and the first table, the second header, and the association relationship between the second header and the first header; wherein the second configuration table is an online table located at the outside of the target database;
generating the second table according to the second configuration table.

According to one or more embodiments of the present disclosure, a data processing method is provided, the number of the second tables is equal or greater than two; the second configuration table further stores the relationships between at least two of the second tables.

According to one or more embodiments of the present disclosure, a data processing method is provided, before updating the data in the second table based on the data in the first table, the method further includes:
verifying the first table, determining the first table meets the verification requirement.

According to one or more embodiments of the present disclosure, a data processing method is provided, verifying the first table, includes at least one of the following:
verifying the data type of the current data in the first table;
verifying the header of the first table;
Verifying the association relationship between the first table and the second table.

According to one or more embodiments of the present disclosure, a data processing method is provided, the method satisfies at least one of the following:
verifying the data type of the current data in the first table including: obtaining the first data type of the data in the first table from the first configuration table; determining the data type of the current data in the first table conforms to the first data type;
verifying the header of the first table including: obtaining the first header of the first table from the first configuration table, determining the current header in the first table is in consistent with the first header stored the first configuration;
verifying the association relationship between the first table and the second table including: determining a target row in the first table is in a frozen state, the target row being used to store the row or column identification of the row or column data in the second table associated with the data of the first table.

According to one or more embodiments of the present disclosure, a data processing method is provided, updating the data in the second table associated with the first table, including:
determining the target header located in the second table associated with the data in the first table;
determining the target row or column data located in the second table associated with the data in the first table;

According to the data in the first table, updating the data corresponding to the target header in the target row or column data in the second table.

According to one or more embodiments of the present disclosure, a data processing method is provided, updating the data in the second table associated with the first table, including:
determining the target header located in the second table associated with the data in the first table;
determining whether the target row or column identification associated with the data in the first table is stored in the target row and row of the first table, the target row or column identification is the identification of the target row or column data in the second table;
If yes, then updating the data corresponding to the target header in the row or column data corresponding to the row or column identification according to the data in the first table;
If otherwise, then creating target row or column data in the second table and obtaining the target row or column identification of the target row or column data, writing the obtained data in the first table to establish an association relationship between the data in the first table and the target row or column identification, based on the data in the first table.

According to one or more embodiments of the present disclosure, a data processing method is provided, determining the target header located in the second table associated with the data in the first table, includes:
determining the header where the data in the first table is located;
determining the target header associated with the header where the data in the first table is located, according to the association relationship between the second header of the second table and the first header of the first table stored in the second configuration table.

According to one or more embodiments of the present disclosure, a data processing method is provided, the method writing the obtained target row or column identification in the first table, includes:
In the target row or column of the first table, the target row or row identification is written and frozen.

According to one or more embodiments of the present disclosure, a data processing method is provided, updating the data in the second table associated with the first table based on the data in the first table, includes:
determining the difference between the data in the first table and the data in the associated second table;
determining the data sets that need to be updated according to the difference;
updating the data of the second table according to the data set.

According to one or more embodiments of the present disclosure, a data processing apparatus is provided, including:
a determining unit, in response to a first operation on a first table, determining data in the first table;
an updating unit, updating data in a second table in a target database based on the data in the first table; wherein, the first table is an online table located outside the target database, the first table and the second table are in an association relationship.

According to one or more embodiments of the present disclosure, an electronic device is provided, including: at least one memory and at least one processor;

wherein, the at least one memory being used to store program code, the at least one processor being used to invoke the program code stored in the at least one memory to execute any one of the methods described above.

According to one or more embodiments of the present disclosure, a computer-readable storage medium is provided. The computer-readable storage medium is used to store program code in response to the program code being run by a processor, the program code causes the processor to execute the above method.

The above description is only a description of the preferred embodiments of the present disclosure and the technical principles used. Those skilled in the art should understand that the disclosure scope involved in the present disclosure is not limited to technical solutions composed of specific combinations of the above technical features, but should also cover solutions composed of the above technical features or other technical solutions formed by any combination of equivalent features without departing from the above disclosed concept. For example, a technical solution is formed by replacing the above features with technical features with similar functions disclosed in the present disclosure (but not limited to).

Furthermore, although operations are depicted in a specific order, this should not be understood as requiring that these operations be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features described in the context of individual embodiments may also be implemented in combination in a single embodiment. Conversely, various features that are described in the context of a single embodiment can also be implemented in multiple embodiments individually or in any suitable sub-combination.

Although the present subject matter has been described in language specific to structural features and/or methodological logical acts, it should be understood that the subject matter defined in the accompanying CLAIMS is not necessarily limited to the specific features or actions described above. Rather, the specific features and actions described above are merely example forms of implementing CLAIMS.

1. A data processing method, comprising:
in response to a first operation on a first table, determining data in the first table;
updating data in a second table in a target database based on the data in the first table; wherein, the first table is an online table located outside the target database, the first table and the second table are in an association relationship.

2. The method of claim 1, wherein, before responding to a first operation of a first table, the method further comprises:
creating the first table based on the target database.

3. The method of claim 2, wherein, creating the first table based on the target database comprises:
displaying a header of a data table of the target database and a data type corresponding to the header;
determining a first header of the first table and a first data type based on the header of the data table of the target database and the data type;
generating the first table according to the first header of the first table and the first data type.

4. The method of claim 3, wherein, determining a first header and a first data type of the first table based on the header of the data table of the target database and the data type comprises: creating a first configuration table, the first configuration table being used to store a first header of the first table, a first data type and an identification of the first table, the first configuration table being an online table located outside the target database;
generating the first table according to the first configuration table.

5. The method of claim 1, wherein, before responding to a first operation of a first table, the method further comprises:
creating the second table associated with the first table in the target database according to relevant information of the first table.

6. The method of claim 5, wherein, creating the second table associated with the first table in the target database according to relevant information of the first table comprises:
determining a second header of the second table and a second data type according to the first header of the first table and the first data type;
creating the second table according to the second header of the second table and the second data type, and associating the first table with the second table.

7. The method of claim 6, wherein,
associating the second table with the first table comprises: creating a second configuration table, the second configuration table being used to store an association relationship between the second table and the first table, the second header, an association relationship between the second header and the first header; wherein, the second configuration table is an online table located outside the target database;
generating the second table according to the second configuration table.

8. The method of claim 7, wherein,
a number of the second tables is equal or greater than two; the second configuration table further stores an association relationship between at least two of the second tables.

9. The method of claim 1, wherein, before updating the data in the second table based on the data in the first table, the method further comprises:
verifying the first table, to determine that the first table meets a verification requirement.

10. The method of claim 9, wherein, verifying the first table comprises at least one of the following:
verifying a data type of current data in the first table;
verifying a header of the first table;
verifying an association relationship between the first table and the second table.

11. The method of claim 10, wherein, at least one of the following is satisfied:
verifying a data type of current data in the first table comprises: obtaining a first data type of data of the first table from a first configuration table; determining a data type of the current data in the first table complying with the first data type;
verifying a header of the first table comprises: obtaining a first header of the first table from a first configuration table; determining a current header in the first table is consistent with a first header stored in the first configuration table;
verifying an association relationship between the first table and second table comprises: determining that a target row or column in the first table is in a frozen state, the target row or column being used to store a row or column identification of row or column data located in the second table associated with data of the first table.

12. The method of claims 1, wherein, updating the data in the second table associated with the first table comprises:
determining a target header located in the second table associated with data in the first table;
determining target row or column data in a second table associated with data in the first table;
updating data corresponding to the target header in the target row or column data of the second table according to data in the first table.

13. The method of claims 1, wherein, updating data in the second table associated with the first table comprises:
determining a target header located in the second table associated with data in the first table;
determining whether a target row or column identification associated with data in a first table is stored in a target row or column of the first table, the target row or column identification being an identification of target row and column data in the second table;
if yes, updating data corresponding to the target header in the row or column data corresponding to the row or column identifier according to data in the first table;
otherwise, creating target row and column data in the second table, and obtaining a target row or column identification of the target row or column data, writing obtained data in the first table to establish an association relationship between data in the first table and the target row or column identification.

14. The method of claim 12-or 13, wherein, determining a target header located in the second table associated with data in the first table comprises:
determining a header where data in the first table is located;
determining the target header associated with the header where data in the first table is located, according to an association relationship between a second header of the second table and a first header of the first table stored in a second configuration table.

15. The method of claim 13, wherein, writing an obtained target row or column identification in the first table comprises:
writing and freezing the target row or column identification in a target row or column of the first table.

16. The method of claim 1, wherein, updating data in the second table associated with the first table based on data in the first table comprises:
determining a difference between data in a first table and data in an associated second table;
determining a data set that needs to be updated based on the difference;
updating data of the second table according to the data set.

17. (canceled)

18. An electronic device, comprising:
at least one memory and at least one processor;
wherein, the at least one memory being used to store program code, the at least one processor being used to invoke the program code stored in the at least one memory to perform operations comprising:
in response to a first operation on a first table, determining data in the first table; updating data in a second table in a target database based on the data in the first table; wherein, the first table is an online table located outside the target database, the first table and the second table are in an association relationship.

19. A non-transitory computer-readable storage medium, the computer-readable storage medium is used to store program code, in response to being run by a processor, the program code causes the processor to perform operations comprising:
in response to a first operation on a first table, determining data in the first table;
updating data in a second table in a target database based on the data in the first table; wherein. the first table is an online table located outside the target database, the first table and the second table are in an association relationship.

20. The electronic device of claim 18, wherein, before responding to a first operation of a first table, the operations further comprise:
creating the first table based on the target database.

21. The electronic device of claim 20, wherein the creating the first table based on the target database comprises:
displaying a header of a data table of the target database and a data type corresponding to the header;
determining a first header of the first table and a first data type based on the header of the data table of the target database and the data type;
generating the first table according to the first header of the first table and the first data type.
